(19) United States
(12) Patent Application Publication
(10) Pub. No.: US 2015/0102768 A1
(43) Pub. Date: Apr. 16, 2015

(54) Electrical Energy Accumulation Device Based on a Gas-Electric Battery

(71) Applicant: Amit Tereshchenko, Haifa (IL)

(72) Inventor: Amit Tereshchenko, Haifa (IL)

(21) Appl. No.: 14/560,181

(22) Filed: Dec. 4, 2014

Related U.S. Application Data
(63) Continuation of application No. PCT/RU2012/000441, filed on Jun. 6, 2012.

(51) Int. Cl. H01M 4/62; H02J 7/00; H01M 2/12; H01M 2/36; H01M 2/02; H01M 10/02

(52) U.S. Cl. CPC H01M 4/628; H01M 2/0237; H01M 10/02; H01M 2/12; H01M 2/362; H02J 7/0052; H01M 2300/0002; H01M 2220/10
USPC 320/107; 429/163; 429/56; 320/128

(57) ABSTRACT

A device for the accumulation of electrical energy contains a gas-electric battery having a hollow housing, partially filled with an electrolyte solution, and electrodes, positioned inside the hollow housing and made of a conductive adsorbent of the electrolysis gases. The electrodes are divided by a gas-permeable separator. Current-collectors linked to the electrodes are connected to a charge-discharge converter designed to allow for a periodic change in the polarity of the charge current during the charging process. The device makes it possible to provide a long operating life with minimal environmental pollution.

### CROSS-REFERENCE TO RELATED APPLICATION(S)

This application is a continuation of International Application No. PCT/RU2012/000441, filed Jun. 6, 2012, which is incorporated herein by reference.

### TECHNICAL FIELD

The invention generally relates to the field of electrotechnology and, in particular, to secondary chemical of electricity that can be used in industrial and household applications.

### BACKGROUND

Several electrochemical energy batteries can be used, either independently or together with different primary electricity generators (e.g., photovoltaic cells, wind generators and other such devices), to even out peaks of energy demand on power grids. In the latter the battery is charged from the grid and releases power into a load during peaks of demand.

One known battery type is the so-called gas-electric battery (see, e.g., RU 2056676 (C1), Arshinov et al., Mar. 20, 1996), which has been widely described in the literature. An earlier publication (SU 48659, Akimushkin, Jul. 12, 1935) describes a gas battery, the effect of which is based on the exploitation of a gaseous galvanic chain that develops in a hermetically sealed housing filled with a solid adsorbent for the gas. When a constant charge current passes between the electrodes, electrolysis of the electrolyte (e.g., a sodium chloride solution) causes the release of hydrogen and chlorine, which are captured by the adsorbent in the areas near the electrode. Hydrogen is adsorbed in the area of the negative electrode and chlorine in the area of the positive electrode, in accordance with the reaction: 2NaCl+2H₂O→H₂+Cl₂+2NaOH.

When the electrodes are connected to a load, a reverse chemical reaction takes place: H₂+Cl₂+2NaOH→2NaCl+2H₂O. The shortfalls of this battery are the clogging of the electrodes, resulting in a reduction of the electric capacity, and also electrolyte deterioration due to an accumulation of NaOH. As a result, the lifetime of the battery is about 100 cycles. The limited lifetime makes it impossible to use this battery on an industrial scale.

Known devices for battery charging (see, for instance, SU 775816, Belonoshko et al., Oct. 30, 1980; RU 2038672 C1, Gulyayev et al, Jun. 27, 1995) use charge-discharge converters for electric energy accumulation systems. However, these devices are not designed for operation in a gas-electric battery, which is characterized by the slowness of the electrochemical reactions that occur, and do not solve the task of extending its lifetime.

Therefore, there is a need for a device for accumulating electrical energy based on a gas battery where the device has a long operating life and minimizes pollution to the environment.

### SUMMARY

Disclosed herein are example aspects of a device for the accumulation of electrical energy comprising a gas-electric battery including a hollow housing partly filled with an electrolyte solution and electrodes positioned in the hollow space of the housing and made of a conductive adsorbent of electrolysis gases. The electrodes may be divided by a gas-permeable separator. Current-collectors connected to the electrodes may be connected to a charge-discharge converter designed to allow for a periodic change in the polarity of the charge current during the charging process.

The conductive adsorbent may be activated carbon, activated carbon black, activated graphite, colloidal carbon, pyrocarbon or mixtures thereof, whereas the electrolyte may be an aqueous sodium chloride solution.

An upper panel of the battery housing may include a protective valve and a valve for creating overpressure in the housing, and an adsorbent layer may be placed under the upper panel of the housing, separated from the electrodes by a separator. Nozzles for supplying and releasing the electrolyte may also be arranged in the housing.

In certain example aspects, a charge-discharge converter may comprise three filters, two of which may be arranged at an inlet and outlet of the converter while the third may be connected to the electrodes of the gas-electric battery. The charge-discharge converter may also comprise three pairs of symmetric two-way switches, a triple-wound transformer, a control unit activating a device for the formation of control voltages, and a control logic. Each of the filters may be connected by one of its outlets to a pair of the two-way switches connected in-series the ends of one of the windings, and by its other outlet to the center of the winding. The inlet of the control unit may be connected to sensors for measuring parameters of the gas-electric battery, while its control outlet is connected to the switches. The sensors for measuring the parameters of the gas-electric battery can activate sensors for voltage, current, temperature, pressure of the gases and the pH of the electrolyte solution.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and particularly pointed out in the claims.

### BRIEF DESCRIPTION OF THE DRAWINGS

The accompanying drawings illustrate one or more example aspects of the invention and serve to explain their principles and implementations.

FIG. 1 illustrates an example aspect of a gas-electric battery.

FIG. 2 illustrates an example aspect of a charge-discharge converter in which two-way switches are used together with a gas-electric battery.

### DETAILED DESCRIPTION

Example aspects are described herein in the context of a device for the accumulation of electrical energy. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

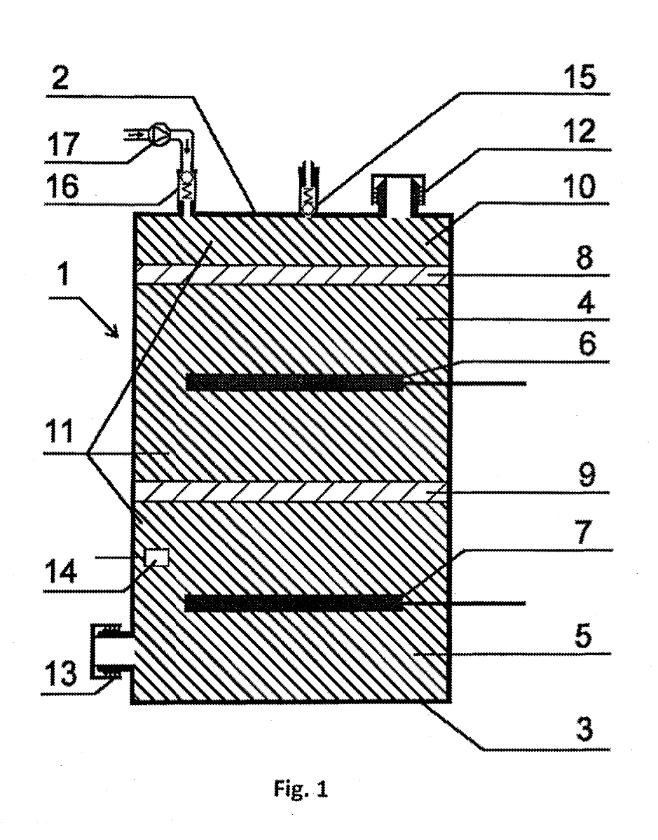

As shown in FIG. 1, a gas-electric battery for use in a device for the accumulation of electrical energy includes a battery 1 having a hollow housing with an upper panel 2 and a floor panel 3. Electrodes 4, 5 arranged in the hollow of the housing are made of a conductive adsorbent for adsorbing gases that form during the electrolysis process. The conductive adsorbent may be activated carbon, activated carbon black, activated graphite, colloidal carbon, pyrocarbon or mixtures thereof. In certain aspects, current-collectors 6 and 7 form an electric energy outlet. The electrodes 4, 5 are separated from each other and also from the adsorbent by separators 8 and 9. To prevent gas leakages, an adsorbent 10 is arranged above the electrodes. The housing of the battery 1 is at least partially filled with electrolyte 11, and to supply and release the electrolyte 11, nozzles 12, 13 are arranged in the housing. To check the function of the battery 1, sensors 14 for measuring parameters, such as voltage, current, temperature, the pressure of the gases and the pH of the electrolyte solution, may be arranged within the housing. A protective valve 15 and a valve 16 for creating overpressure in the housing, connected to a pump 17, are arranged on an upper panel 2 of the housing 1.

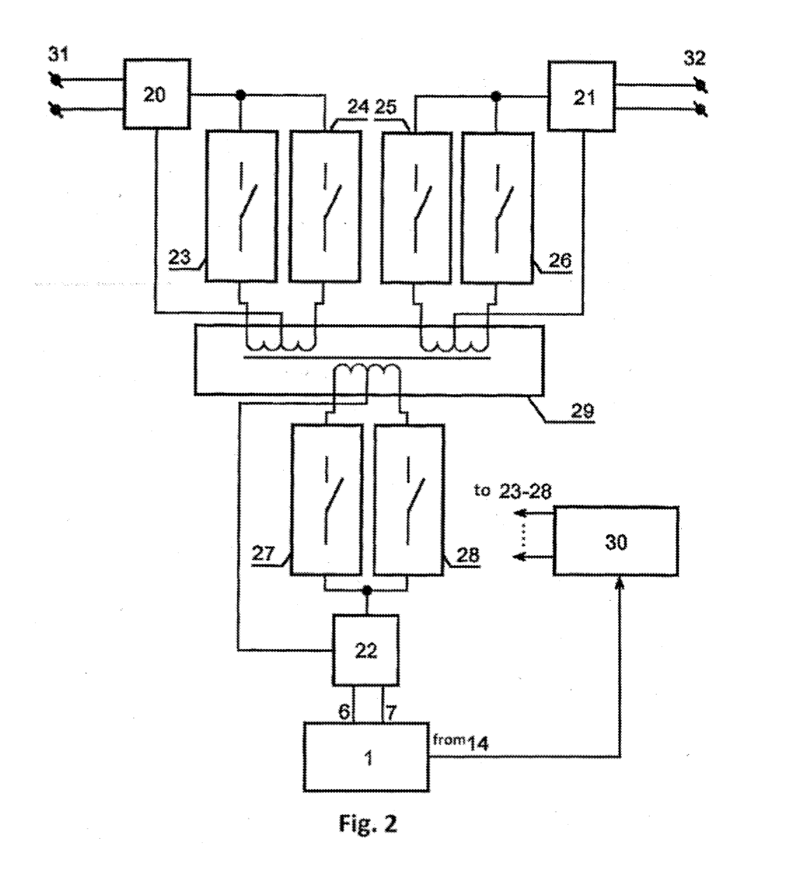

As shown in FIG. 2, the gas battery 1 can function within a charge-discharge converter. Notably, in certain example aspects, it is possible to use separate charge and discharge converters that switch over when the processes of charging and discharging are finished.

The charge-discharge converter may also function as a voltage stabilizer and includes three filters 20, 21, 22, three pairs of symmetric two-way switches 23-24, 25-26, 27-28, a triple-wound transformer 29 and a control unit 30. Two filters 20 and 21 are arranged at the inlet 31 and at the outlet 32 of the converter, which is connected to a load or grid, while a third filter 22 is connected to current-collectors 6 and 7 of electrodes 4, 5 of the gas-electric battery 1. The control unit 30 includes control logic as well as a control voltage formation device for the switches 23-24, 25-26, 27-28. Each of filters 20, 21 and 22 are connected by a corresponding outlet to a pair of two-way switches 23-24, 25-26 or 27-28 that are connected in series to the ends of windings of transformer 29, and with their other outlet at the center of the respective winding. The inlet of control unit 30 is connected to sensors 14 for receiving parameters of the gas-electric battery 1, while the outlet of control unit 30 is connected to switches 23-24, 25-26, 27-28.

The triple-wound transformer 29 provides a decoupling between the inlet 31 and the outlet 32 of the converter, which makes it possible to provide a charge and discharge converter in the same device, and also to stabilize the outlet voltage to improve the power factor of consumption from a source, and to release excess power back into the power grid. The operating frequency of the converter is dependent on the elements to be employed and can be between tens and hundreds of kilohertz. Filters 20, 21, 22 prevent transfer of frequency from the converter into the power grid, load or battery, eliminate parasitic harmonics, provide necessary impedance, and provide a reduction in the level of electromagnetic interferences.

The device works in the following manner. In a charging mode, inlet voltage 31 passes through filter 20 to switches 23, 24 to function as a push-pull converter. By means of the transformer 29, the converted voltage passes to a synchronous rectifier provided on the switches 27, 28 then through the filter 22 to the battery 1, thereby charging it. Simultaneously, the converted voltage from the transformer 29 can be rectified by switches 25, 25 to function as a pulsed voltage stabilizer, and passes through filter 21 to the outlet 32 (exit voltage stabilization mode).

In a discharging mode, the voltage from battery 1 passes through filter 22 to switches 27, 28, this voltage is converted into a high-frequency voltage. The converted voltage passes from the transformer 29 to a synchronous rectifier provided on the switches 25, 26 for rectification, then passes through the filter 21 to outlet 32. Switches 23, 24 can be in either a switched-off state, in a converter mode, depending on the control pulses of the control unit 30 to increase the power at the outlet (modes of equalizing the demand peaks or correcting the power), or in a synchronous rectifier mode (mode of returning a part of the power into the power grid).

Switches 23-28 are controlled according to signals from the voltage formation device of the control unit 30, which includes sensors 14 for measuring the parameters of voltage, current, temperature, pressure of the gases and the pH of the electrolyte solution, and also the control logic.

In the charging mode, the voltage from a source of energy (for instance, from a photovoltaic cell), which passes to inlet 31 of the converter, is converted into a charge current passing through current-collectors 6 and 7 to electrodes 4 and 5. Under the influence of electric current, electrolysis process takes place in the electrolyte 11. The electrolyte solution 11 dissolves, forming reaction products and releasing gaseous components. When a sodium chloride solution is used as the electrolyte 11, the products, hydrogen and chlorine, are adsorbed by the unwound surface of the electrodes 4 and 5, while in the electrolyte 11, sodium hydroxide (NaOH) is accumulated according to the following chemical reaction: 2NaCl+2H₂O←→H₂+Cl₂+2NaOH.

The battery capacity is defined by the surface area of the conductive adsorbent, for instance, activated carbon, which forms the body of the electrodes. When the battery is discharged, the adsorbent gases are released from the electrodes 4 and 5 and again join the reaction with sodium hydroxide to form the sodium chloride solution. However, water insoluble salts (for instance, calcium salts and others) contained in the material of the electrodes 4, 5 and the electrolyte 11 can precipitate onto the electrodes 4, 5 and reduce sorption capacity (i.e., the usable area of the electrodes) correspondingly reducing electric capacity. Furthermore the hydrogen may be retained by the electrode material which is essentially worse than chlorine, and after discharging the battery, part of the chlorine may remain on the electrode.

When the polarity of the converter in the charging mode changes, residues of the gases flow from the electrodes to the outside where they interact with a different gas which starts forming in the electrolysis process. The chemical reaction between the gases results in the formation of hydrochloric acid, which dissolves the water insoluble salts, thus cleansing the electrodes 4, 5. A portion of the gases formed in the electrolysis process are released from the surface of the electrodes and accumulate under the top panel 2 of the housing 1. To prevent their leaking and, as a consequence, a deterioration of the properties of the electrolyte 11, an additional layer of adsorbent 10, for example activated carbon, is arranged above the electrodes 4, 5.

While it alternately (at the change of polarity) adsorbs various gases, a chemical reaction occurs, wherein hydrochloric acid is formed, which is neutralized by alkali that forms during electrolysis. The resulting sodium chloride solution is used again in the electrolysis process. The degree of adsorption depends on the pressure. It is possible to increase the degree of adsorption and thus increase the battery capacity by raising the pressure within the housing, to which end it is possible to use valve 16 for creating an overpressure from pump 17 within the housing.

To check the parameters of the battery 1, sensors 14 can be arranged within it to measure basic operation parameters of battery function, such as the temperature, the pressure, the pH, the number of activations of the protective valve, the electrolyte level. In the event of an overcharging of the battery 1, for instance in the event of a failure of the charge converter or a failure of a pressure sensor, the gas pressure within the housing can rise above a permissible level. To prevent a destruction of the housing, the device can be provided with a protective valve 15. Information from the sensors can be transmitted to a service team to assess the necessity of maintenance or repair, which has a positive impact on the safety and lifetime of the device.

Experiments have shown that the relative accumulation capacity, defined as the relationship of the actual value to the value in the first cycle, depending on the number of “charging-discharging” cycles, remains within permissible boundaries for a number reaching several thousand cycles. Simultaneously, in a battery of identical construction it was reduced by a multiplicity of ten when charging was done without changing the polarity of the charge current.

The device can be applied in alternative electrical energies together with photovoltaic cells, wind generators and other similar electricity generators. The device can also be used to even out peaks in demand of electric power by users of electricity grids which enhances the effectiveness of usage of existing electric power stations and electric power transmission lines, reduces the deficit in electric power, and makes it possible to avoid cyclic power cutoffs. The device can be carried out using traditional technologies, materials and elements. The device can withstand total discharges as well as quick charging with increased current without suffering damage, and is constructed in a simple way from readily available materials.

In the interest of clarity, not all of the routine features of the aspects are disclosed herein. It will be appreciated that in the development of any actual implementation of the invention, numerous implementation-specific decisions must be made in order to achieve the developer's specific goals, and that these specific goals will vary for different implementations and different developers. It will be appreciated that such a development effort might be complex and time-consuming, but would nevertheless be a routine undertaking of engineering for those of ordinary skill in the art having the benefit of this disclosure,

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

Those of ordinary skill in the art will realize that the above description is illustrative only and is not intended to be in any way limiting. Other aspects will readily suggest themselves to those skilled in the art having the benefit of this disclosure. Moreover, it would be apparent to those skilled in the art having the benefit of this disclosure that many more aspects and modifications than mentioned above are possible without departing from the inventive concepts disclosed herein.

1. A device for accumulation of electrical energy, comprising
a gas-electric battery, comprising:
a hollow housing;
an electrolyte solution within the housing;
electrodes arranged within the housing, the electrodes comprising a conductive adsorbent for electrolysis gases;
a gas-permeable separator dividing the electrodes; and
current-collectors connected to the electrodes; and
a charge-discharge converter connected to the current-collectors, wherein the converter is adaptable to a periodic change in a polarity of a charge current during a charging process.

2. The device according to claim 1, wherein the conductive adsorbent is selected from a group consisting of activated carbon, activated carbon black, activated graphite, colloidal carbon, pyrocarbon and mixtures thereof.

3. The device according to claim 1, wherein the electrolyte solution is an aqueous sodium chloride solution.

4. The device according to claim 1, wherein a protective valve and a valve for creating overpressure in the housing are arranged on an upper panel of the housing.

5. The device according to claim 4, wherein an adsorbent layer is placid under the upper panel of the housing, separated from the electrodes by a separator.

6. The device according to claim 1, wherein nozzles for supplying and releasing the electrolyte solution are arranged in the housing.

7. The device according to claim wherein the charge-discharge converter comprises:
a filter at an inlet of the converter, a filter at an outlet of the converter and a filter connected to the electrodes of the gas-electric battery;
a plurality of pairs of symmetric two-way switches;
a triple-wound transformer comprising a plurality of windings;
a control unit activating a device for forming control voltages; and
a control logic,
wherein each filter is connected to a respective one of the pairs of two-way switches connected in-series to a respective one of the windings, and wherein each filter is connected to a center of the respective one of the windings, and
wherein a control unit inlet is connected to sensors for measuring parameters of the gas-electric battery, and wherein a control unit outlet is connected to the plurality of pairs of two-way switches.

8. The device according to claim 7, wherein the parameters are selected from a group consisting of voltage, current, temperature, gas pressure and pH of the electrolyte solution.

9. A method of charging and discharging a gas-electric battery comprising:
providing the device of claim 1;
charging the battery comprising: receiving an inlet voltage via a converter inlet and converting the inlet voltage to form a converted voltage, wherein the converter operates as a push-pull converter; and receiving the converted voltage by the battery to charge the battery;
stabilizing an outlet voltage of the converter comprising; receiving the converted voltage by an outlet rectifier; rectifying the converted voltage; and stabilizing the outlet voltage with the rectified voltage; and
discharging the battery comprising: converting a battery discharge voltage to form a converted discharge voltage; receiving the converted discharge voltage by the outlet rectifier;
rectifying the converted discharge voltage to form the outlet voltage; and discharging the outlet voltage through a converter outlet.

10. The method of claim 9, wherein the received inlet voltage is from one or more of a power grid or a generator.

11. The method of claim 10, wherein the grid is one or more of an electric power station or an electric power transmission line, and wherein the generator is one or more of a photovoltaic cell or a wind generator.

12. The method of claim 9, wherein when the polarity of the converter changes during the charging or the discharging of the battery, an electrolysis reaction within the battery shifts

13. The method of 12, wherein an intermediate reaction of the electrolysis reaction removes impurities from the electrodes of the battery.

14. The method of claim 9, wherein charging the battery comprises: generating an electrolysis reaction within the battery to release gases from the electrolyte solution, wherein the gases adsorb onto the electrodes of the battery.

15. The method of claim 9, wherein discharging the battery comprises: generating a reverse electrolysis reaction within the battery to dissolve gases adsorbed on the electrodes of the battery into the electrolyte solution.
